(19) United States
(12) Patent Application Publication
(10) Pub. No.: US 2003/0134086 A1
(43) Pub. Date: Jul. 17, 2003

(54) Diffuse-reflection surfaces and process for their production

(75) Inventors: Edwin Nun, Billerbeck (DE); Markus Oles, Hattingen (DE); Bernhard Schleich, Recklinghausen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: CREAVIS Gesellschaft fur Tech. und Innovation mbH, Marl (DE)

(21) Appl. No.: 10/293,302

(22) Filed: Nov. 14, 2002

(30) Foreign Application Priority Data
Dec. 6, 2001 (DE) 10160055.0

(51) Int. Cl. B32B 1/00

(52) U.S. Cl. 428/143

(57) ABSTRACT

Diffuse-reflection surfaces which have a matte appearance and which have self-cleaning properties and preferably have antimicrobial properties, are prepared by coating a substrate with a random distribution of the particles to at least one surface of a substrate, thereby providing a surface comprising elevations with a height of from 20 nm to 100 μm and with a separation of less than 100 μm between the elevations. Such diffuse-reflection surfaces can be used as protective covers or as protective layers, in particular for providing non-angle-dependent viewing. The diffuse reflection surfaces of the present invention have self-cleaning properties and are resistant to colonization by microorganisms.

### BACKGROUND OF THE INVENTION

1. Field of the Invention

The present invention relates to diffuse-reflection surfaces which are self-cleaning and preferably have antimicrobial properties, articles having such surfaces, and also to processes for their production and use.

2. Discussion of the Background

Very recently, matte, diffuse-reflection surfaces have again become the subject of great interest. Instrument displays, safety or danger markings, or even simple text or graphics are difficult to discern from all viewing angles and at all times if the materials used are reflective or give directional reflection.

Matte-effect materials are well known. For example, flat roofed buildings in particular make use of plastic skylights which are not fully transparent. The surface of these materials is often roughened to achieve the matte effect, for example by mechanical action or chemical action, e.g. etching.

A disadvantage of roughened surfaces is that these surfaces become opaque relatively rapidly (internally and externally) due to the adsorption of particles of dirt or dust, thus reducing the amount of light passing through the material. In addition, when a roughened surface is wetted with water, at least a partial loss of the antireflective action is observed. DE 42 18 215 describes a method for circumventing this disadvantage by producing a matte-effect glass brick which has the roughened surface in its interior. However, the production of glass bricks of this type is relatively complicated and cannot be adopted for every other possible material.

In an entirely different industrial sector, articles are known which have surfaces which are extremely difficult to wet, known as Lotus-effect surfaces. Such surfaces have a large number of economically significant features, in particular the self-cleaning nature of these surfaces. Since the cleaning of surfaces is time-consuming and costly, self-cleaning surfaces are therefore of very great economic interest.

The mechanisms of adhesion are generally the result of surface-energy-related parameters acting between the two surfaces which are in contact. These surfaces generally attempt to reduce their free surface energy. If the free surface energies between two materials (i.e., two surfaces in contact) are intrinsically very low, it can generally be assumed that there will be weak adhesion between these two materials. The important factor here is the relative reduction in free surface energy. In pairings where one surface energy is high and one surface energy is low the crucial factor is very often the opportunity for interactive effects. For example, when water is applied to a hydrophobic surface, it is impossible to bring about any noticeable reduction in surface energy. This is evident in that the wetting is poor. The water applied forms droplets with very high contact angles. Perfluorinated hydrocarbons, e.g. polytetrafluoroethylene, have very low surface energy. There are hardly any materials which adhere to surfaces of this type, and materials deposited on surfaces of this type are in turn very easily removed.

The use of hydrophobic materials, such as perfluorinated polymers, for producing hydrophobic surfaces is known. A further development of these surfaces consists in structuring the surfaces in the μm to nm range. U.S. Pat. No. 5,599,489 discloses a process in which a surface can be rendered particularly dirt repellent by roughening the surface via bombardment with particles of an appropriate size, followed by perfluorination of the surface. Another process is described by H. Saito et al. in “Surface Coatings International” 4, 1997, pp. 168 et seq. Here, particles made from fluoropolymers are applied to metal surfaces, whereupon a marked reduction was observed in the water wettability of the resultant surfaces, thereby providing a considerable reduction in the icing property of the surface.

There are numerous publications which describe the preparation of self-cleaning surfaces, for example U.S. Pat. No. 3,354,022, WO 96/04132, and WO 00/58410. Surfaces of this type are always described and/or claimed for the purpose of maintaining surface cleanliness, generally toward surface contamination with dust. When water is set in motion as a result of rain, drizzle, condensation from fog, or artificial sprinkling with water, for example by a water jet from a water hose, the dust becomes fixed to the water droplets and are removed as the droplets roll off the surface. The surfaces may also be transparent materials. However, there is no description of the production or use of light-scattering surfaces with self-cleaning properties.

EP 1040874 describes self-cleaning surfaces which are transparent if the dimension of the structuring is 400 nm or below and which have high transmittance and, respectively, good optical properties. However, EP 1040874 does not describe the phenomenon of matte-effect or of non-directional reflection. The surfaces described in EP 1040874 are provided, at least to some extent, by embossing of a periodic structure. These are quite unsuitable for the production of matte-effect materials, since periodic structures can generate interference phenomena and scatter light, and therefore generate a bright, angle-dependent rainbow effect.

### SUMMARY OF THE INVENTION

It is an object of the present invention, therefore, to provide matte-appearance, diffuse-reflection surfaces with self-cleaning properties, which preferably also at the same time retard colonization by microorganisms. Surprisingly, it has been found that coating the surface of a substrate with a random distribution of particles of size from 20 nm to 100 μm provides diffuse-reflection surfaces with self-cleaning properties.

In a second embodiment, the present invention also provides a process for producing diffuse-reflection surfaces with an artificial surface structure, which have self-cleaning properties. The process entails depositing a coating on at least one surface of a substrate, where the coating has a random distribution of the particles. The random distribution of particles provides a surface having elevations with a height of from 20 nm to 100 μm and with a separation of <100 μm between the elevations. The surface structure produced thereby has a matte-effect or diffuse-reflection and self-cleaning properties.

### DETAILED DESCRIPTION OF THE INVENTION

The present invention therefore provides diffuse-reflection surfaces based on a light-transmitting, that is to say transparent or translucent, coating which provides an artificial surface structure having elevations and depressions. The coating comprises a random distribution of the particles which provides a surface having elevations with a height of from 20 nm to 100 μm and with a separation of less than 100 μm between the elevations. The resulting surface structure has light-scattering and self-cleaning properties.

The principal property of the diffuse-reflection surfaces of the invention, in addition to the self-cleaning and inhibition of microorganism growth properties, is that they do not reflect light directionally but scatter it diffusely. When traffic signs are coated with films which have been rendered self-cleaning by an embossing process, the embossed surface may result in interference phenomena which causes changes in the apparent color of the surface, and in turn danger to the moving traffic. The diffuse-reflection surfaces of the invention have the advantage of avoiding this interference disadvantage by using a random distribution of particles and therefore achieving a non-periodic surface structure. In addition, the surfaces of the present invention retard colonization by algae and by other microorganisms.

The diffuse-reflection surfaces of the present invention are described in more detail below, but there is no intention that the surfaces be restricted to this description. The surfaces of the present invention are based on light-transmitting, i.e. transparent or translucent, coatings on at least one surface of a substrate, which provide an artificial surface structure comprising elevations and depressions formed from a random distribution of particles. The resulting surface structure has antireflective and self-cleaning properties, and is distinguished by the fact that the surface structure has elevations with a height of from 20 nm to 100 μm and with a separation of less than 100 μm between the elevations.

Particularly good self-cleaning properties are achieved in combination with good diffuse-reflection properties if the surface structure has hydrophobic elevations with a height of from 50 nm to 200 μm, preferably from 50 nm to 100 μm, and very particularly preferably from 0.1 to 20 μm, and preferably with a separation of from 50 nm to 75 μm, very particularly preferably from 500 nm to 5 μm.

It can be advantageous for the coating of the present invention to have antimicrobial properties. Articles having surfaces of this type, according to the present invention, with antimicrobial properties, have the advantage that light is scattered diffusely rather than directionally for a longer period than for conventional articles, since soiling of the surface, and therefore of the area which transmits light, proceeds significantly more slowly. The reason for this is that the adhesion and spread of biological contamination, e.g. bacteria, fungi, and algae, is significantly slowed, and there is therefore longer retention of the effective self-cleaning properties of the diffuse-reflection surfaces. The antimicrobial properties are preferably achieved by incorporating at least one material with antimicrobial properties into the coating. Particularly suitable materials of this type are homo- or copolymers of 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, or 3-aminopropyl vinyl ether.

The elevations and depressions of the surface structure are formed by applying, to the surface of a substrate, a coating which comprises a random distribution of particles. The particles may be secured to the surface of the substrate by any conventional means, preferably by means of a binder system.

Particular binder systems which may be used are UV-curable, thermally curable, or air-curing coating systems. Coating systems include lacquer-like mixtures made from monounsaturated acrylates or methacrylates with polyunsaturated acrylates or methacrylates, and also mixtures of polyunsaturated acrylates or, respectively, methacrylates with one another. Urethane-based lacquer systems are also suitable coating systems. The mixing ratios may be varied within wide limits. Depending on the structure-forming component to be added subsequently, other functional groups may be added, for example hydroxy groups, ethoxy groups, amines, ketones, isocyanates, or the like, or else fluorine-containing monomers or inert filler components, such as polymers soluble in a monomer mixture. The additional functionality serves mainly to improve the binding of the structure-formers. Other binder systems which may be used are pure acrylate dispersions and PU lacquer systems (polyurethane lacquer systems). It can be advantageous for the binder system to also comprise a material which has antimicrobial properties.

The particles are preferably hydrophobic particles. However, it can also be advantageous for the particles to be a mixture of hydrophobic particles and particles with antimicrobial properties. The surface of the present invention particularly preferably comprises a mixture of hydrophobic particles and particles with antimicrobial properties, and which has, based on the weight of the particle mixture, from 0.01 to 25% by weight, preferably from 0.1 to 20% by weight, and very particularly preferably from 1 to 15% by weight, content of particles with antimicrobial properties.

It is preferable to use hydrophobic or hydrophobicized particles having a diameter of from 0.02 to 100 μm, particularly preferably from 0.1 to 50 μm, and very particularly preferably from 0.3 to 30 μm. The surface structures of the present invention have separations of from 0 to 10 particle diameters, in particular from 0 to 3 particle diameters, between the separate particles on the surface. The diameters of the antimicrobial, hydrophilic particles may preferably be from 1 to 2000 μm, preferably from 2 to 1000 μm, and very particularly preferably from 50 to 500 μm.

In order to substantially avoid interference, it may be advantageous for the surface structure to be formed by particles or, respectively, particle fractions which have differing particle sizes or particle diameters. The surface structure preferably comprises at least two particle fractions whose average particle size differs by a factor of from 2 to 10, preferably by a factor of from 4 to 7. This is a decisive difference from systems which occur naturally or are similar to those occurring naturally, since almost all naturally occurring self-cleaning surfaces have a glossy appearance.

The particles may also be present in the form of aggregates or agglomerates, where, according to DIN 53 206, aggregates have (primary) particles in edge- or surface-contact, while agglomerates have (primary) particles in point-contact. The particles used may also be those formed by combining primary particles to give agglomerates or aggregates whose size is from 0.2 to 100 μm.

It can be advantageous for the hydrophobic or hydrophobicized particles to have a structured surface. Preferably, these particles may have an irregular fine nanostructure on the surface. The fine structure of the particles is preferably a fissured structure with elevations and/or depressions in the nanometer range. The average height of the elevations is preferably from 20 to 500 nm, particularly preferably from 50 to 200 nm. The separation between the elevations and, respectively, depressions on the particles is preferably less than 500 nm, very particularly preferably less than 200 nm. These depressions, e.g. craters, crevices, notches, clefts, apertures, or cavities, reinforce the effectiveness of the particle structure. Other structural features, such as undercuts in the depressions or combinations of the various depressions, increase the effectiveness of these particles.

The hydrophobic particles which may be used are transparent and/or translucent particles which comprise at least one material selected from the group consisting of silicates, doped or fumed silicates, minerals, metal oxides, silicas, and polymers. The particles, in particular hydrophobic particles, which have an irregular fine nanostructure on the surface are preferably particles which comprise at least one compound selected from the group consisting of fumed silica, aluminum oxide, silicon oxide, mixed oxides, fumed silicates, and pulverulent polymers. It can be advantageous for the surface of the invention to comprise particles which have hydrophobic properties. The hydrophobic properties of the particles may be inherently present by virtue of the material used for the particles. However, it is also possible to use hydrophobicized particles, e.g. those which have hydrophobic properties by virtue of treatment with at least one compound selected from the group consisting of alkylsilanes, perfluoroalkylsilanes, paraffins, waxes, fatty esters, functionalized long-chain alkane derivatives, and alkyldisilazanes.

The particles having antimicrobial properties and generally having hydrophilic properties preferably comprise homo- or copolymers selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1 propanesulfonic acid, 2-diethylaminoethyl vinyl ether, and 3-aminopropyl vinyl ether.

The diffuse-reflection surface of the present invention may be applied to all or a portion of the surface of a molding made from a material selected from the group consisting of polymers, copolymers, and polymer blends of, e.g. polyamides, polyurethanes, polyether block amides, polyester amides, polyvinyl chloride, polyolefins, polysilicones, polysiloxanes, polymethyl methacrylates, polyterephthalates, metals, ceramics, and glasses. The list of polymeric materials is merely given by way of example, and the materials are not restricted to those listed. If the molding comprises a polymer, the molding may advantageously comprise a polymer with antimicrobial properties.

The diffuse-reflection surfaces of the present invention may be applied either to semifinished products, or to molded articles or items, films, sheets, plates, or the like. The diffuse-reflection surfaces may be applied to one, two, or more sides of articles. Surfaces with surface structures which have self-cleaning and light-scattering properties may also be applied in the form of transparent or translucent films to a reflective article. The present invention also encompasses articles produced in this way with diffuse-reflection surfaces.

The diffuse-reflection surfaces of the invention are preferably produced by the process of the present invention for producing diffuse-reflection surfaces with an artificial surface structure which has light-scattering and self-cleaning properties. This process produces a surface structure which has elevations with a height of from 20 nm to 100 μm and with a separation of less than 100 μm between the elevations by applying a specific coating with a random distribution of the particles to at least one surface of a substrate. The application of the coating and the attachment of the particles to the surface may take place in a manner known to the skilled worker. An example of a chemical method which may be used for the attaching the particles according to the process of the present invention is the use of a binder system. Various adhesives, adhesion promoters, or lacquers may be used as the binder system of the present invention, with the proviso that the binder system is transparent or translucent. Other binder systems or chemical fixing methods will be apparent to the skilled worker.

It may be advantageous for at least one material which has antimicrobial properties to be used during the production of the surface structures.

The material which has antimicrobial properties may be present in the surface of the substrate coated, and also in the binder system or particle system. At least some of the particles may preferably comprise a material which has antimicrobial properties. The antimicrobial material used is preferably a homo- or copolymer prepared from 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyl dimethylammonium bromide, 2-methacryloyloxyethyl-4-benzoyldimethylammonium bromide, 2-acrylamido-2-methyl-1-propanesulfonic acid, 2-diethylaminoethyl vinyl ether, or 3-aminopropyl vinyl ether.

It is very particularly preferable for a particle mixture which comprises particles with antimicrobial properties to be applied to the surface. It is advantageous for the particle mixture to comprise a mixture of structure-forming, preferably hydrophobic particles, and particles with antimicrobial properties. Based on the weight of the particle mixture, the particles with antimicrobial properties may be present in an amount of from 0.01 to 25% by weight, preferably from 0.1 to 20% by weight, and very particularly preferably from 1 to 15% by weight. The particles having antimicrobial properties may, of course, also contribute to the formation of the light scattering structure. The balance of structure-forming and antimicrobial particles must be such that the antimicrobial activity is generated, but the coating retains the dominance of the hydrophobic properties needed for self-cleaning.

An example of a method for applying the particle mixture to a surface to generate the surface structure of the present invention, and the antimicrobial properties is as follows. A binder system, which may be a curable substance, is applied to a surface by spray, doctor knife, spreader, or jet. The thickness of the curable substance applied is preferably from 1 to 200 μm, preferably from 5 to 75 μm. Depending on the viscosity of the curable substance, it may be advantageous to permit the substance to begin to cure before applying the particles. Ideally, the viscosity of the curable substance is selected so as to permit the particles applied to sink at least to some extent into the curable substance, but to prevent the flow of the curable substance and, respectively, of the particles applied thereto when the surface is placed vertically.

An example of the method for applying the particles is spray-application. In particular, the particles may be applied by spray-application using an electrostatic spray gun. Once the particles have been applied, excess particles, i.e. particles not adhering to the curable substance, may be removed from the surface by shaking, or by being brushed off or blown off. These particles may be collected and reused.

In one preferred embodiment of the process of the invention, the particles may be fixed to the surface by curing a binder system, preferably by the application of energy in the form of heat and/or light. Preferably, the binder system is cured by light. The curing of the binder preferably takes place in an inert gas atmosphere, very particularly preferably in a nitrogen atmosphere.

The particles which form the surface structure are preferably hydrophobic or hydrophobicized transparent and/or translucent particles which comprise at least one transparent and/or translucent material selected from the group consisting of silicates, doped or fumed silicates, minerals, metal oxides, silicas, and polymers, preferably in the form of an aggregate or agglomerate. It is particularly preferable to use particles whose particle diameter is from 0.02 to 100 μm, particularly preferably from 0.1 to 50 μm, and very particularly preferably from 0.3 to 30 μm. The hydrophobic particles preferably comprise primary particles with an average primary particle diameter of from 5 to 50 nm. These primary particles are then preferably in agglomerated or aggregated form, where the aggregates or agglomerates have diameters of from 20 nm to 100 μm.

It can be advantageous to use particle mixtures having at least two fractions of particles having different size distributions. This method can prevent the regular arrangement of particles of the same size, and thus prevent the production of interference patterns. It is preferable to use at least two fractions which differ in average particle sizes by a factor of from 2 to 10, preferably from 4 to 7. The particles used may, of course, also comprise a particle fraction which has particles of different sizes.

The particles which provide the self-cleaning surfaces preferably have hydrophobic properties. The particles may themselves be hydrophobic, e.g. particles comprising PTFE, or the particles may have been hydrophobicized. The hydrophobicization of the particles may take place in a manner known to the skilled worker, e.g. by way of treatment of a particle with at least one compound selected from the group consisting of alkylsilanes, perfluoroalkylsilanes, paraffins, waxes, fatty esters, functionalized long-chain alkane derivatives, and alkyldisilazanes. Examples of typical hydrophobicized particles are very fine powders, such as Aerosil R 974 or Aerosil R 8200 (Degussa AG), which are commercially available.

The hydrophobic, transparent and/or translucent particles, or the subsequently hydrophobicized, transparent and/or translucent particles, are preferably those which comprise at least one material selected from the group consisting of silicates, doped silicates, minerals, metal oxides, mixed metal oxides, fumed silicas, precipitated silicas, and polymers. The particles very particularly preferably comprise silicates, fumed silicas or precipitated silicas, in particular Aerosils, SiO₂, TiO₂, ZrO₂ or pulverulent polymers, e.g. cryogenically milled or spray-dried polytetrafluoroethylene (PTFE).

It is particularly preferable to use hydrophobic particles with a BET surface area of from 50 to 600 m²/g. It is very particularly preferable to use particles which have a BET surface area of from 50 to 200 m²/g.

The particles having antimicrobial properties may comprise homo- or copolymers prepared from 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, or 3-aminopropyl vinyl ether. The particles may be composed entirely of the material having antimicrobial properties, or have a coating of the antimicrobial material. It is particularly preferable to use particles which have antimicrobial properties and whose diameter is from 1 to 2000 μm, particularly preferably from 20 to 1000 μm, and very particularly preferably from 5 to 500 μm.

The particles with antimicrobial properties must not be hydrophobicized, since the presence of a hydrophobicizing reagent on the surface of the particle causes loss of the antimicrobial property.

The coated substrate may be at least one portion of the surface of a molding made from a material selected from the group consisting of polymers (homopolymers, copolymers, and polymer blends), e.g. polyamides, polyurethanes, polyether block amides, polyester amides, polyvinyl chloride, polyolefins, polycarbonates, polystyrenes, polysilicones, polysiloxanes, polymethyl methacrylates, polyterephthalates, ceramics, metals, and mineral glasses. The list of polymeric materials is given only by way of example and the materials are not restricted to those listed. If the molding is made from polymers, it can be advantageous for the molding to comprise a polymer with antimicrobial properties. Moldings of the present invention may be either semifinished products, molded articles or items, films, sheets, plates, or the like. The process of the invention may be used to generate diffuse-reflection surfaces of the invention on one, two or more sides of a material or molding, where the diffuse-reflectance surfaces have self-cleaning and light-scattering properties.

The process of the present invention provides diffuse-reflection surfaces with self-cleaning properties having excellent properties. Materials having such diffuse-reflection surfaces may be used to produce traffic placards, traffic signs, safety markings, or protective covers for instruments, or to produce other articles, such as advertising medium surfaces or systems for guiding pedestrians or vehicles. The diffuse-reflection surfaces of the present invention have the advantage that when illuminated they do not dazzle the observer. In addition, the information presented on articles of this type, according to the present invention, can be read by an observer from angles down to 20°, preferably extending as far as an angle of down to 10° with respect to the area on which the information is presented.

Thus, for the above reasons, traffic placards, traffic signs, safety markings, protective covers for instruments, and also advertising medium surfaces and apparatus for guiding pedestrians or vehicles have particularly good properties when they comprise the diffuse-reflection surfaces of the present invention.

The diffuse-reflection surfaces of the present invention, having a random distribution of particles, have the particular advantage that they ensure the uniform distribution of light over the entire surface provided with the surface structure of the present invention.

Traffic placards provided with the diffuse-reflection surfaces of the present invention have good discernibility whatever the location and angle of observation, since the self-cleaning properties of the surface structure ensure that the soiling of these placards proceeds much more slowly than with conventional placards. Of course, this is also applicable to (safety) instructions on buildings or at fabrication sites, to traffic signs, to systems for guiding pedestrians or vehicles, to advertising medium surfaces, to safety markings, and to protective covers for instruments.

The examples below provide further illustration of the surface of the invention, and also of a process for its production, but there is no intention that the invention be restricted to these examples.

### EXAMPLE 1

20% by weight of methyl methacrylate, 20% by weight of pentaerythritol tetraacrylate, and 60% by weight of hexanediol dimethacrylate were mixed together. 14% by weight of Plex 4092 F (an acrylic copolymer from Rohm GmbH) and 2% by weight of Darokur 1173 UV curing agent based on the weight of the above mixture, were then added and stirred for at least 60 min. The highly-crosslinking, UV-curable acrylate mixture was applied at a thickness of 10 μm to an extruded polymethyl methacrylate sheet of thickness 3 mm, and then Aerosil R 8200 particles were applied by electrostatic coating. This lacquer/particle coating was cured by means of UV radiation at wavelength 308 nm, under nitrogen. An inscription was adhesive-bonded to the underside of the PMMA sheet. The sheet was laid flat and visual determination showed that legibility of the inscription continued to an angle of 10° with respect to the plane of the sheet.

A reflectometer was used to determine the reflection properties of the surface. The variable obtained is a dimensionless number. The smaller this number, the more diffuse the light. The values given are the average of 4 separate measurements.

Measured at 20°: 3.7

Measured at 60°: 7.9

Measured at 85°: 2.9

### COMPARATIVE EXAMPLE 1:

The following results were given by the system used in Example 1, but without any application of particles:

The inscription became indecipherable below 20° with respect to the plane of the coated sheet. The reflection measurements obtained were:

At 20°: 147.8

At 60°: 149.7

At 85°: 117.6

The priority document of the present application, German patent application 10160055.0 filed Dec. 6, 2001, is incorporated herein by reference.

Obviously, numerous modifications and variations on the present invention are possible in light of the above teachings. It is therefore to be understood that within the scope of the appended claims, the invention may be practiced otherwise than as specifically described herein.

What is claimed as new and is intended to be secured by letters

1. A diffuse-reflection surface, comprising:
a substrate coated with a coating comprising a random distribution of particles, thereby providing a surface having elevations,
wherein said elevations have a height of from 20 nm to 100 μm and have a separation of less than 100 μm between the elevations,
said coating is light-transmitting, and
the surface has light-scattering and self-cleaning properties.

2. The diffuse-reflection surface of claim 1,
wherein the coating further comprises a material having antimicrobial properties.

3. The diffuse-reflection surface of claim 1,
wherein the coating further comprises a binder system.

4. The diffuse-reflection surface of claim 3, wherein the binder system is selected from the group consisting of UV-curable, thermally curable, or air-curing coating systems.

5. The diffuse-reflection surface of claim 4, wherein the binder system comprises mixtures prepared from monounsaturated acrylates and/or methacrylates with polyunsaturated acrylates and/or methacrylates, mixtures of polyunsaturated acrylates or methacrylates with each other, or urethane lacquers.

6. The diffuse-reflection surface of claim 1,
wherein the particles comprise a mixture of hydrophobic particles and particles having antimicrobial properties.

7. The diffuse-reflection surface of claim 2,
wherein the material having antimicrobial properties comprises at least one antimicrobial polymer which has been prepared from at least one monomer selected from the group consisting of 2-tert-butylaminoethyl methacrylate, 2-diethylaminoethyl methacrylate, 2-diethylaminomethyl methacrylate, 2-tertbutylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

8. The diffuse-reflection surface of claim 6, wherein the mixture of the particles comprises from 0.01 to 25% by weight of particles with antimicrobial properties, based on the weight of the particle mixture.

9. The diffuse-reflection surface as claimed in claim 1,
wherein the substrate is a molding prepared from a material selected from the group consisting of polymers, polyamides, polyurethanes, polyether block amides, polyester amides, polyvinyl chloride, polyolefins, polysilicones, polysiloxanes, polymethyl methacrylates, polyterephthalates, ceramics, metals, and glasses.

10. The diffuse-reflection surface of claim 1, wherein the particles comprise at least two particle fractions whose average particle size differs by a factor of from 2 to 10

11. The diffuse-reflection surface of claim 1, wherein the particles comprise at least two particle fractions whose average particle size differs by a factor of from 4 to 7.

12. A process for producing the diffuse-reflection surface of claim 1, comprising:
applying a coating comprising a random distribution of particles to at least one surface of a substrate, thereby providing a surface comprising elevations with a height of from 20 nm to 100 μm and with a separation of less than 100 μm between the elevations.

13. The process of claim 12, wherein the coating further comprises at least one material which has antimicrobial properties.

14. The process of claim 12, further comprising fixing the particles to the substrate.

15. The process of claim 12, wherein the coating further comprises a binder system.

16. The process of claim 14, wherein said fixing comprises coating said substrate with a binder system, and applying said random distribution of particles to said binder system.

17. The process of claim 16, wherein said binder system is cured by heat or light after said applying.

18. The process of claim 12, wherein the particles comprise a mixture of hydrophobic particles and particles having antimicrobial properties.

19. The process of claim 15, wherein said substrate, particles, and/or the binder system further comprises an antimicrobial material.

20. The process of claim 19, wherein the antimicrobial material comprises a polymer which has been prepared from at least one monomer selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

21. The process of claim 12, wherein the particles comprise a mixture of transparent and/or translucent hydrophobic particles which comprise at least one material selected from the group consisting of silicates, doped silicates, minerals, metal oxides, silicas, polymers, and homo- or copolymers selected from the group consisting of 2-tert-butylamino ethyl methacrylate, 2-diethylamino ethyl methacrylate, 2-diethylaminomethyl methacrylate, 2-tert-butylaminoethyl acrylate, 3-dimethylaminopropyl acrylate, 2-diethylaminoethyl acrylate, 2dimethylaminoethyl acrylate, dimethylaminopropylmethacrylamide, diethylaminopropylmethacrylamide, N-3-dimethylaminopropylacrylamide, 2-methacryloyloxythyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

22. The process of claim 21, wherein the hydrophobic particles have an average primary particle diameter of from 5 to 50 nm.

23. The process of claim 22, wherein the primary particles have substantially an agglomerated or aggregated form, and the diameter of the aggregates or agglomerates is from 20 nm to 100 μm.

24. The process of claim 18, wherein the diameter of the particles with antimicrobial properties is from 20 to 2000 μm.

25. The process of claim 12, wherein the particles have a surface comprising an irregular fine nanostructure.

26. The diffuse-reflection surface of claim 1, wherein the substrate is in the form of a film, sheet, or plate.

27. A traffic sign comprising the diffuse-reflection surface of claim 1.

28. A safety marking comprising the diffuse-reflection surface of claim 1.

29. A printed film, sheet, or plate comprising the diffuse-reflection surface of claim 1.

30. A system for guiding pedestrians or vehicles comprising the diffuse-reflection surface of claim 1.

31. A protective cover for an instrument comprising the diffuse-reflection surface of claim 1.
